(19) United States
(12) Patent Application Publication
(10) Pub. No.: US 2010/0017740 A1
(43) Pub. Date: Jan. 21, 2010

(54) PAN AND ZOOM CONTROL

(75) Inventors: Monica Estela Gonzalez Veron, Seattle, WA (US); Daniil Magdalin, Kirkland, WA (US); Ionela Mirela Vals, Redmond, WA (US); Alice Pritikin Steinglass, Redmond, WA (US); Heather Joy O'Cull, Seattle, WA (US); Eric McQuaid Zenz, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/175,447

(22) Filed: Jul. 17, 2008

(51) Int. Cl. G06F 3/048

(52) U.S. Cl. 715/777

(57) ABSTRACT

Technologies are described herein for providing a pan and zoom control in conjunction with a timeline for navigating project schedule data in a project management application. The project management application displays a pan and zoom control in conjunction with a project schedule timeline, with the pan and zoom control at a position and of a size relative to the timeline that reflects the temporal scope of project schedule data currently displayed. The pan and zoom control is configured to allow a user to move and resize the control along the timeline. Upon detecting movement or resizing of the pan and zoom control, the project management application will change the scope of the project schedule data displayed to match the time period represented by the new position and/or new size of the pan and zoom control in relation to the timeline.

### BACKGROUND

A project management application is a computer application program that allows a user to manage tasks associated with a project. The project management application allows the user to define tasks for the project, create a schedule for the completion of the tasks, project time and budget for each task, assign resources required to complete a task, specify project goals and milestones, and otherwise carry out and manage the project. The project management application stores the task and schedule data and displays the project schedule to the user in a standard format.

For example, a project management application may display a project schedule containing task information using a Gantt chart to graphically plot the tasks on a timescale to indicate the start and finish date of each task. A Gantt chart typically shows a list of tasks on the left side of a display, and a bar chart on the right side of the display. The bar chart graphically shows the task information on a timescale defined by the user such that detailed task information may be examined and compared. As the number of tasks in the schedule increases, however, the Gantt chart may only be able to display a subset of the project schedule in sufficient detail to be useful, making it difficult to see how a specific task fits into the larger, overall project schedule.

In order to provide this high-level overview of the project schedule, the project management application may display a project schedule timeline in conjunction with the Gantt chart or other schedule data. The timeline provides a summary of the project schedule by visually representing the schedule along a timescale from the start of the project until the finish. The timeline may also display crucial time information about the project including phases and milestones. However, even with the high-level overview provided by the project schedule timeline, a user might still not be able to relate the current scope of tasks displayed in the Gantt chart to the overall project schedule displayed in the timeline.

It is with respect to these considerations and others that the disclosure made herein is presented.

### SUMMARY

Technologies are described herein for providing a pan and zoom control in conjunction with a timeline for navigating project schedule data in a project management application. The pan and zoom control is displayed along the timeline in a position and of a size that corresponds to the time period or scope of the project schedule data currently displayed by the project management application. This allows the user to see how the currently displayed data fits temporally in the overall project schedule. In addition, the user can move and resize the pan and zoom control along the timeline to select a different time period for which to display the project schedule data in the project management application.

According to aspects presented herein, when the project management application detects the display of a timeline, the project management application determines the scope of any project schedule data displayed. The project management application then displays the pan and zoom control in proximity to the timeline at a position and of a size relative to the timeline that reflects the scope of the displayed data. In one aspect, the pan and zoom control is configured to allow a user to move and resize the control along the timeline. Upon detecting movement or resizing of the pan and zoom control, the project management application determines the time period represented by the new position and/or new size of the pan and zoom control in relation to the timeline and changes the scope of the project schedule data displayed to match the time period.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing an illustrative computer hardware and software architecture for a computing system capable of implementing aspects of the embodiments presented herein;

FIGS. 2A-2C are screen diagrams showing an exemplary user interface for displaying a pan and zoom control in conjunction with a project schedule timeline, according to embodiments described herein;

FIG. 3 is a screen diagram showing a further exemplary user interface for displaying a pan and zoom control in conjunction with a project schedule timeline, according to embodiments described herein; and

FIGS. 4A-4B show a flow diagram showing one method for providing a pan and zoom control in conjunction with a timeline for navigating project schedule data, as provided in the embodiments described herein.

### DETAILED DESCRIPTION

The following detailed description is directed to technologies for providing a pan and zoom control in conjunction with the display of a timeline for navigating project schedule data in a project management application. While the subject matter described herein is presented in the general context of an application program that operates in conjunction with the execution of an operating system on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which show by way of illustration specific embodiments or examples. Referring now to the drawings, in which like numerals represent like elements through the several figures, aspects of a computing system and methodology for providing a pan and zoom control in conjunction with the display of a project schedule timeline will be described.

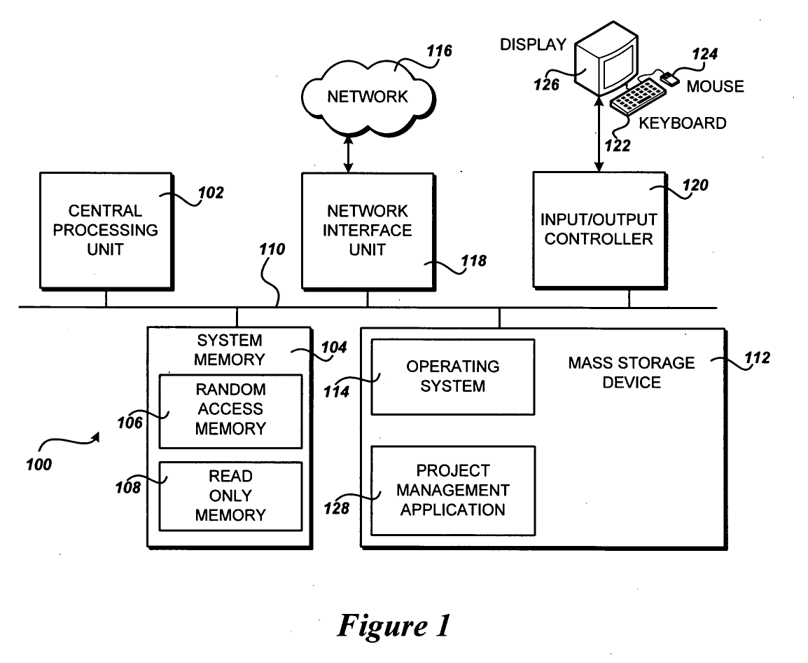

Turning now to FIG. 1, details will be provided regarding an illustrative operating environment and several software components provided by the embodiments presented herein. In particular, FIG. 1 shows an illustrative computer architecture for a computer 100 capable of executing the software components described herein for providing a pan and zoom control in conjunction with the display of a project schedule timeline. The computer architecture shown in FIG. 1 illustrates a conventional desktop, laptop, or server computer and may be utilized to execute any aspects of the software components presented herein.

The computer architecture shown in FIG. 1 includes a central processing unit 102 (CPU), a system memory 104, including a random access memory (RAM) 106 and a read-only memory (ROM) 108, and a system bus 110 that couples the memory to the CPU 102. A basic input/output system containing the basic routines that help to transfer information between elements within the computer 100, such as during startup, is stored in the ROM 108. The computer 100 further includes a mass storage device 112 for storing an operating system 114, application programs, and other program modules, which are described in greater detail herein.

The mass storage device 112 is connected to the CPU 102 through a mass storage controller (not shown) connected to the bus 110. The mass storage device 112 and its associated computer-readable media provide non-volatile storage for the computer 100. Although the description of computer-readable media contained herein refers to a mass storage device, such as a hard disk or CD-ROM drive, it should be appreciated by those skilled in the art that computer-readable media can be any available computer storage media that can be accessed by the computer 100.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and can be accessed by the computer 100.

According to various embodiments, the computer 100 may operate in a networked environment using logical connections to remote computers through a network such as the network 116. The computer 100 may connect to the network 116 through a network interface unit 118 connected to the bus 110. It should be appreciated that the network interface unit 118 may also be utilized to connect to other types of networks and remote computer systems. The computer 100 may also include an input/output controller 120 for receiving and processing input from a number of other devices, including user input devices like a keyboard 122, mouse 124, or electronic stylus. Similarly, an input/output controller may provide output to a display 126, a printer, or other type of output device.

As mentioned briefly above, a number of program modules and data files may be stored in the mass storage device 112 and RAM 106 of the computer 100, including an operating system 114 suitable for controlling the operation of a networked desktop, laptop, or server computer. The mass storage device 112 and RAM 106 may also store one or more program modules. In particular, the mass storage device 112 and the RAM 106 may store a project management application 128 that provides the functionality presented herein for providing a pan and zoom control in conjunction with the display of a project schedule timeline, as described in detail below. According to embodiments, the project management application 128 comprises the MICROSOFT® PROJECT project management application from MICROSOFT CORPORATION of Redmond, Wash. It should be appreciated, however, that the embodiments presented herein may be utilized with project management application software from other vendors, including, but not limited to, PRIMAVERA 6.0 (P6™) software from PRIMAVERA SYSTEMS, INC. of Bala Cynwyd, Pa. OMNIPLAN software from OMNI DEVELOPMENT, INC. of Seattle, Wash., and ARTEMIS software from ARTEMIS INTERNATIONAL SOLUTIONS CORPORATION of Austin, Tex. The mass storage device 112 and the RAM 106 may also store other types of program modules or data.

It will be further appreciated that, while the embodiments provided herein are described as executing as traditional client applications on the computer 100, they may also be implemented using a client-server model, such as Web-based applications executing on a server computer and accessed over the public Internet or through a private Intranet by a Web browser application executing on a client computer 100.

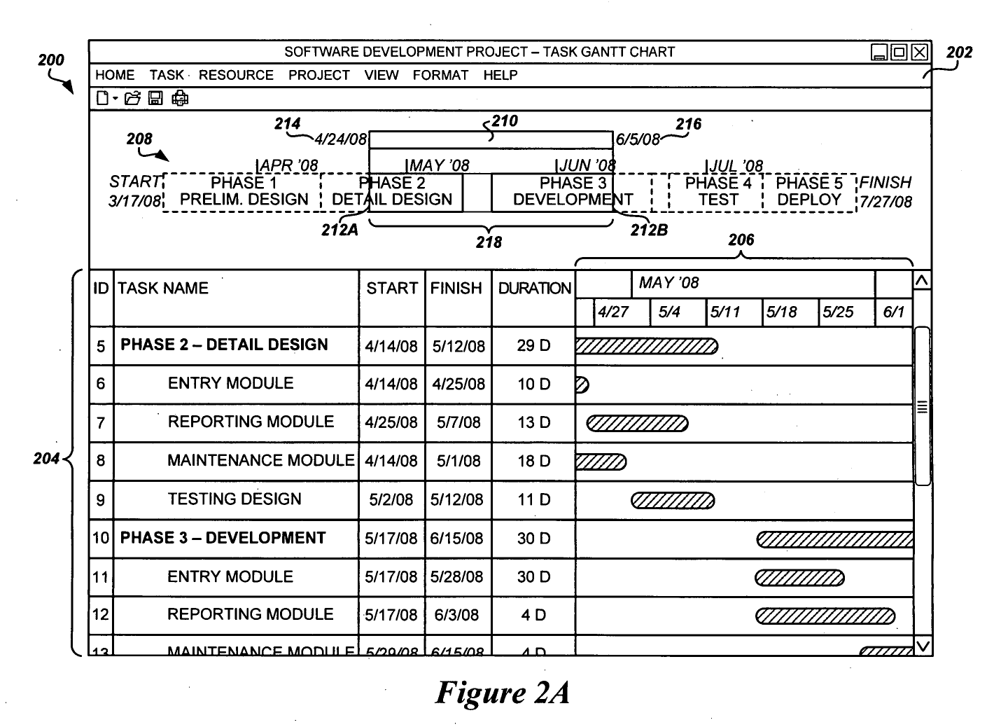

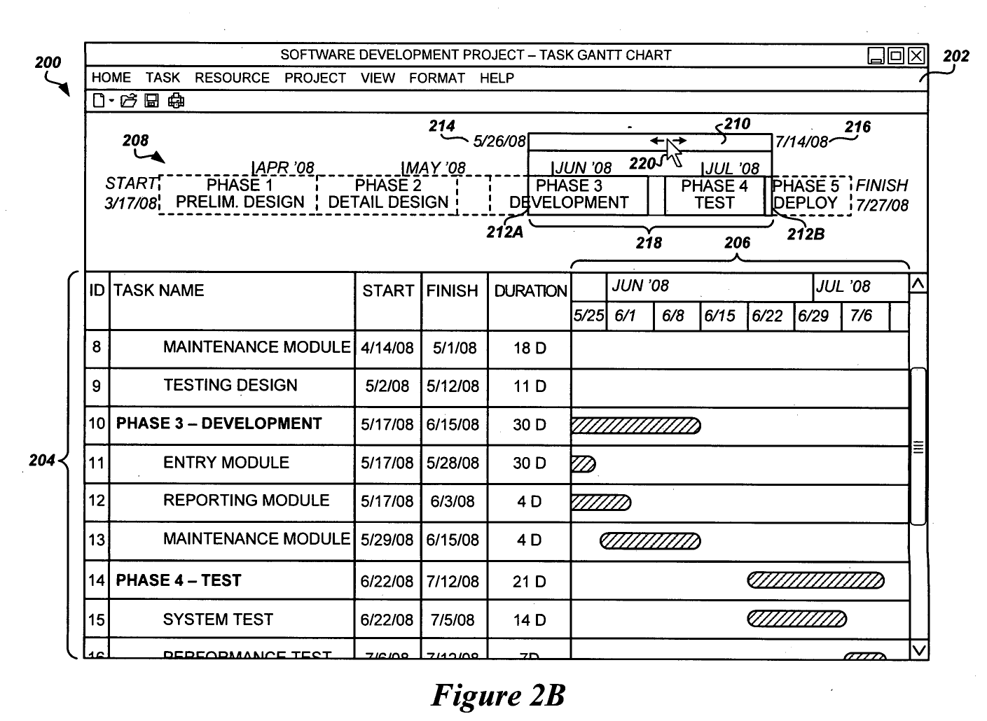

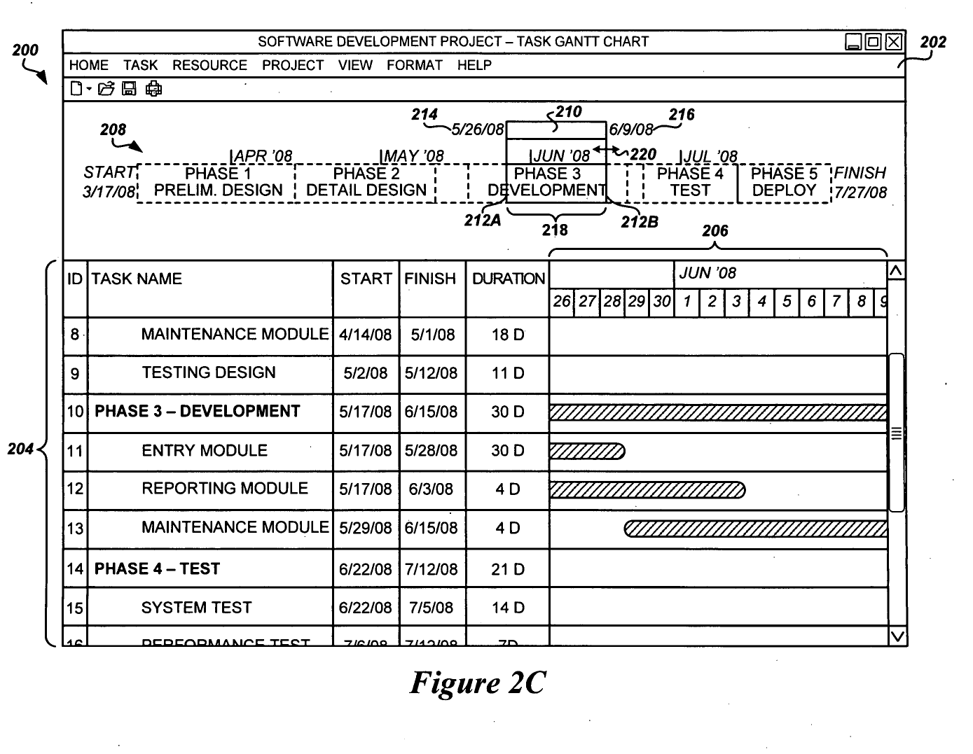

FIGS. 2A-2C illustrate an exemplary user interface (UI) 200 that may be generated by the project management application 128 to display the pan and zoom control in conjunction with a project schedule timeline. In particular, the UI 200 illustrated in FIG. 2A includes a window 202 rendered by the project management application 128. The window 202 displays project schedule data 204 containing task information regarding a number of tasks in a project schedule. It will be appreciated that the display provided by the project management application 128 may also be shown in a windowless mode of operation, such as a full screen display mode.

The project schedule data 204 includes a Gantt chart that graphically plots the tasks on a timescale to indicate the start and finish date of each task. In one embodiment, the temporal scope 206 of the Gantt chart displayed in the window 202 may include only a portion of the overall project schedule. The scope 206 for display of data in the Gantt chart may be determined by the project management application 128 based upon the necessary detail required to display the task data, or the scope 206 may be set by the user of the project management application 128 to display the portion of the project schedule desired. In a further embodiment, the scope 206 of the Gantt chart may include the entire project schedule.

The window 202 also includes a project schedule timeline 208 rendered by the project management application 128 that provides a high-level overview of the project schedule. In one embodiment, the timeline 208 is displayed horizontally in the window 202 with a timescale that runs from the beginning of the project schedule to the end of the project schedule. For example, the timeline 208 illustrated in FIG. 2A depicts a project schedule running from Mar. 17, 2008 to Jul. 27, 2008. The project management application 128 may also display task groupings, milestones, or other schedule data along the timeline 208, such as the five task groupings, or “phases,” illustrated in FIG. 2A. It will be appreciated that the project schedule timeline 208 may be rendered by the project management application 128 in any number of ways that provide a high-level overview of the project schedule.

According to embodiments, when the scope 206 of the Gantt chart or other project schedule data 204 displayed in the window 202 includes only a portion of the overall project schedule, the project management application 128 renders a pan and zoom control 210 in proximity to the timeline 208. In one embodiment, the pan and zoom control 210 is rendered as a horizontal bar above the timeline 208. The project management application 128 renders the pan and zoom control 210 in a position along the timeline 208 and of a size in relation to the timeline 208 corresponding to the scope 206 of the project schedule data 204. The pan and zoom control 210 may include lines 212A, 212B or other UI components which extend from either end of the horizontal bar onto the timeline 208 to clearly show the portion 218 of the timeline 208 encompassed by the pan and zoom control 210. In addition, the pan and zoom control 210 may further include a start date 214 displayed at one end of the horizontal bar and an end date 216 displayed at the other end of the horizontal bar, further indicating the time period represented by the portion 218 of the timeline 208 encompassed by the pan and zoom control 210.

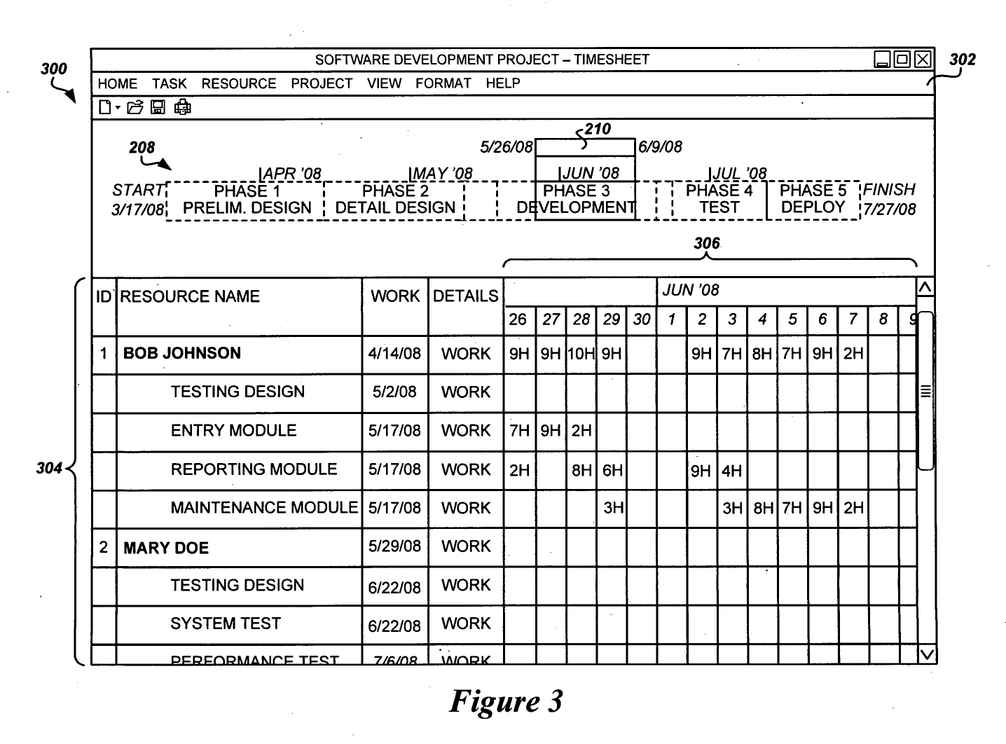

For example, as illustrated in FIG. 2A, the project management application 128 may render the pan and zoom control 210 over the timeline 208 described above at a position and of a size to encompass a portion 218 of the timeline 208 corresponding to the time period from Apr. 24, 2008 to Jun. 5, 2008. This time period roughly matches the scope 206 of the Gantt chart rendered by the project management application 128 in the window 202. While the pan and zoom control 210 is depicted in illustrations provided herein as a horizontal bar placed above the project schedule timeline 208, it will be appreciated that many variations in the form and placement of the pan and zoom control 210 will be apparent to those of ordinary skill in the art, and this application is intended to cover any such variations beyond those illustrated in FIGS. 2A-2C and 3.

In a further embodiment, the project management application 128 may alter the display attributes of the project schedule timeline 208 to differentiate the portion 218 of the timeline 208 encompassed by the pan and zoom control 210 from the remainder of the timeline 208. For example, as illustrated in FIG. 2A, the portion 218 of the timeline 208 encompassed by the pan and zoom control 210 may be rendered with solid lines, while the remainder of the timeline falling outside the portion 218 may be rendered with dashed lines. It should be appreciated that many methods of altering the display attributes of the timeline 208 may be imagined by one skilled in the art, including changing the colors, shading, or transparency of different sections of the timeline to differentiate the portion 218 of the project schedule timeline 208 encompassed by the pan and zoom control 210 from the portions of the timeline 208 outside the control 210.

According to embodiments disclosed herein, the pan and zoom control 210 is configured to allow users of the project management application 128 to move and resize the control 210. This allows the users to change the scope 206 of the project schedule data 204 currently displayed in the window 202. FIG. 2B illustrates the effect on the UI 200 from a user moving the pan and zoom control 210 along the project schedule timeline 208. In one embodiment, a user may move the pan and zoom control 210 described above using a mouse 124 attached to the computer 100. The user may use the mouse 124 to position a mouse cursor 220 over the pan and zoom control 210, and, while holding down a button on the mouse 124, drag the control 210 horizontally along the project schedule timeline 208. Moving the pan and zoom control 210 in this fashion changes the portion 218 of the timeline 208 encompassed by the control 210. In turn, the project management application 128 will change the scope 206 of the project schedule data 204 displayed in the window 202 to match that of the time period corresponding to the portion 218 of the timeline 208 encompassed by the pan and zoom control 210.

For example, as illustrated FIG. 2B, a user may drag the pan and zoom control 210 to a position along the project schedule timeline 208 such that it encompasses a portion 218 corresponding to the time period from May 26, 2008 to Jul. 14, 2008. As the pan and zoom control 210 is dragged along the timeline 208, the project management application 128 may alter the display attributes of the timeline 208 to reflect the new portion 218 encompassed by the pan and zoom control 210. In addition, the project management application 128 may update the start date 214 and end date 216 to reflect the time period corresponding to the portion 218 of the timeline 208 currently encompassed by the pan and zoom control 210.

Once movement of the pan and zoom control 210 is complete, the project management application 128 updates the scope 206 of the Gantt chart or other project schedule data 204 displayed in the window 202 to match the new portion 218 of the timeline 208 encompassed by the control 210. It will be appreciated that the project management application 128 may update the display of the pan and zoom control 210 and the scope 206 of the Gantt chart to reflect the new position of the pan and zoom control 210 dynamically as the control 210 is moved along the timeline 208, upon completion of the movement of the control 210, or in some combination of the two.

Similarly, FIG. 2C illustrates the affect on the UI 200 from a user resizing the pan and zoom control 210 in relation to the project schedule timeline 208. The user may use the mouse 124 to position the mouse cursor 220 over either end of the pan and zoom control 210 or the lines 212A, 212B extended below the ends of the pan and zoom control 210. Upon the mouse cursor 220 being placed in this position, the project management application 128 may change the type of the cursor 220 displayed to indicate that the pan and zoom control 210 is to be resized.

The user may then use the mouse 124 to drag the selected end of the pan and zoom control 210, widening or narrowing the control 210 to encompass a larger or smaller portion 218 of the timeline 208. Once the pan and zoom control 210 is resized, the project management application 128 will change the scope 206 of the project schedule data 204 displayed in the window 202 to match that of the time period corresponding to the portion 218 of the timeline 208 encompassed by the pan and zoom control 210.

For example, as illustrated FIG. 2C, a user may drag the line 212B at one end of the pan and zoom control 210 inward, changing the size of the control 210 in relation to the project schedule timeline 208 such that it encompasses a portion 218 corresponding to the time period from May 26, 2008 to Jun. 9, 2008. The project management application 128 may update the start date 214, end date 216, and display attributes of the timeline 208 accordingly. In addition, the project management application 128 changes the scope 206 of the Gantt chart or other project schedule data 204 displayed in the window 202 to match the new time period. While the examples provided herein describe the pan and zoom control 210 being moved and resized by the user using a mouse 124, it will be appreciated that the user may utilize any input device to move and resize the pan and zoom control 210, including, but not limited to, a mouse 124, keyboard 122, trackball, touchpad, stylus, touch-screen or other input device that may be directly connected to the computer 100 or remotely connected via a network 116.

In further embodiments, the pan and zoom control 210 and project schedule timeline 208 described herein may be rendered in conjunction with other views of project schedule data beyond the Gantt chart view illustrated in FIGS. 2A-2C. For example, FIG. 3 shows a UI 300 rendered by the project management application 128, including the project schedule timeline 208 and the pan and zoom control 210 utilized in conjunction with the display of a timesheet view of project schedule data 304 in a window 302. Just as described above in regard to the Gantt chart, the scope 306 of the project schedule data 304 displayed in the timesheet view corresponds to the position and size of the pan and zoom control 210 in relation to the timeline 208. It will be further appreciated that the pan and zoom control 210 and project schedule timeline 208 described may be rendered in conjunction with any graphical or tabular views of project schedule data that display the data along a timescale.

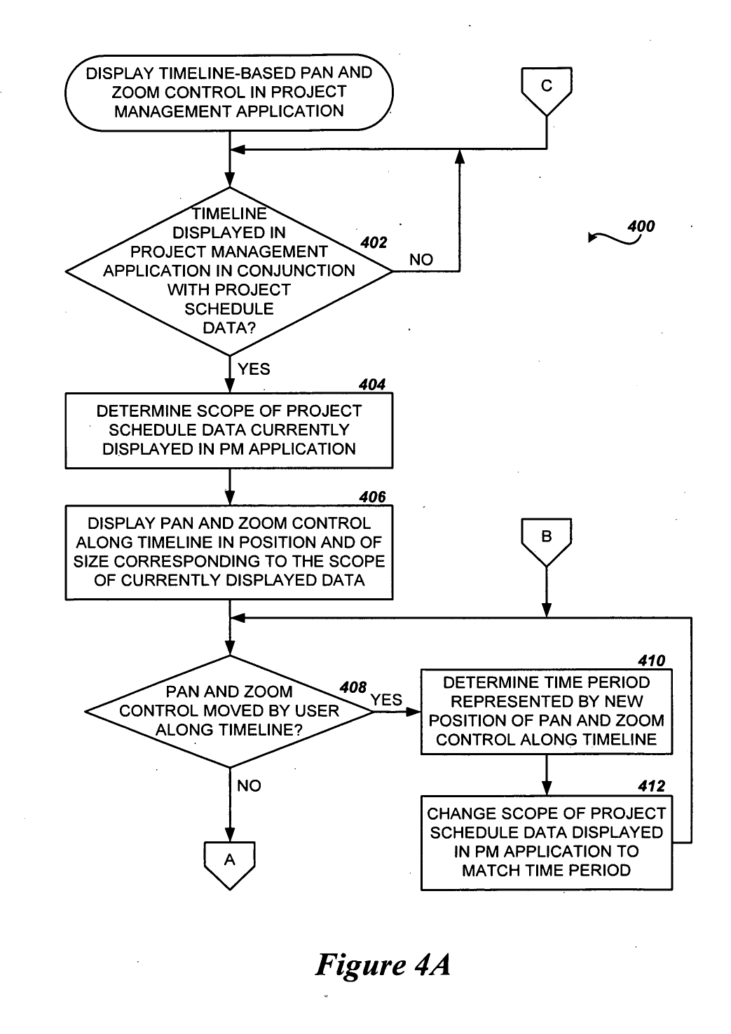

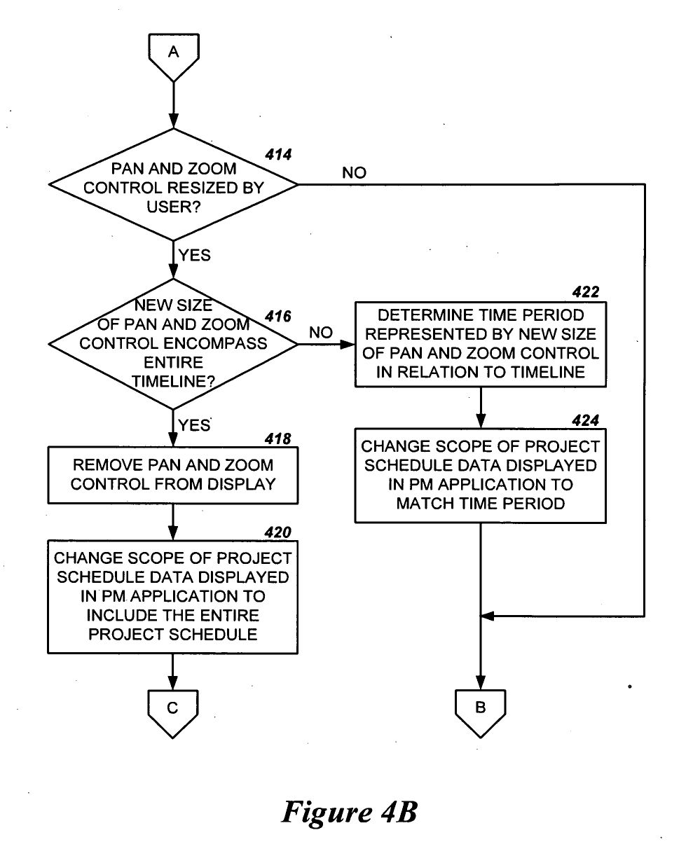

Referring now to FIGS. 4A-4B, additional details will be provided regarding the embodiments presented herein. In particular, FIGS. 4A-4B are a flow diagram showing one method for providing a pan and zoom control in conjunction with the display of a timeline for navigating project schedule data in a project management application. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. These operations may also be performed in a different order than those described herein.

The routine 400 begins at operation 402, where the project management application 128 detects that a project schedule timeline 208 is displayed in conjunction with project schedule data 204 presented by the application. This may occur whenever a Gantt chart, timesheet view, or other project schedule data 204 is displayed by the project management application 128. The timeline 208 may also be displayed in response to a user of the project management application 128 selecting a “view timeline” or similar control from the application UI. If the project management application 128 detects the display of the project schedule timeline 208, then the routine 400 proceeds from operation 402 to operation 404, where the project management application 128 determines the scope 206 of the displayed project schedule data 204. According to embodiments, this scope 206 is simply the time period covered by the project schedule data 204 currently displayed.

From operation 404, the routine 400 proceeds to operation 406, where the project management application 128 displays the pan and zoom control 210 in proximity to the timeline 208. As described above in regard to FIG. 2A, the pan and zoom control 210 is displayed along the timeline 208 in a position and of a size corresponding to the scope 206 of the displayed data as determined in operation 404. According to one embodiment, the project management application 128 does not display the pan and zoom control 210 if the scope 206 of the displayed data includes the entire project schedule. In this case, the pan and zoom control 210 may be subsequently rendered by the project management application 128 if the scope 206 of data is changed such that it no longer includes the entire project schedule. For example, if the user utilizes a control in the UI of the project management application 128 to manually alter the scope 206 of the displayed data, the project management application 128 will render the pan and zoom control 210 along the timeline 208 to correspond to the modified scope 206.

As described above, the pan and zoom control 210 is configured to allow users of the project management application 128 to move and resize the control 210, according to embodiments. If, at operation 408, the project management application 128 detects that the user has moved the pan and zoom control 210 along the timeline 208, the routine 400 proceeds to operation 410, where the project management application 128 determines the time period corresponding to the portion 218 of the timeline 208 encompassed by control 210 at its new position. This may be accomplished by comparing the relative size and position of the pan and zoom control 210 as displayed to the size and position of the project schedule timeline 208, and applying this comparison to the date range of the overall project schedule represented by the timeline display. It will be appreciated that the project management application 128 may utilized any number of methods known in the art to determine the time period corresponding to the portion 218 of the timeline 208 encompassed by the pan and zoom control 210.

The routine 400 proceeds from operation 410 to operation 412, where the project management application 128 changes the scope 206 of the project schedule data 204 to include data within the new time period determined in operation 410. The project management application 128 also updates the start date 214, end date 216, display attributes of the timeline 208, and the timescale displayed for the project schedule data to reflect the new time period, as described above in regard to FIG. 2B. From operation 412, the routine 400 returns to operation 408, where the project management application 128 waits for any additional movement or resizing of the pan and zoom control 210 by the user.

Similarly, if the project management application 128 at operation 414 detects that the pan and zoom control 210 has been resized in relation to the timeline 208 by the user, then the routine 400 proceeds to operation 416, where the project management application 128 determines whether the new size of the pan and zoom control 210 encompasses the entire project schedule timeline 208. According to one embodiment, if the pan and zoom control 210 is resized by the user such that it encompasses the entire timeline 208, the routine proceeds from operation 416 to operation 418 where the project management application 128 removes the pan and zoom control 210 from the display. From operation 416, the routine the routine 400 proceeds to operation 420, where the project management application 128 changes the scope 206 of the displayed project schedule data 204 to the entire project schedule. The routine 400 then returns to operation 402 where the project management application 128 waits for the scope 206 of the displayed data to be changed by the user, as described above in regard to operation 406.

If, however, the resized pan and zoom control 210 does not encompass the entire timeline 208 at operation 416, the routine 400 proceeds to operation 422, where the project management application 128 determines the time period corresponding to the portion 218 of the timeline 208 encompassed by the pan and zoom control 210 at its new size, as described above in regard to operation 410. The routine then proceeds to operation 424, where the project management application 128 changes the scope 206 of the displayed project schedule data 204 to include data within the new time period determined in operation 420, as illustrated in FIG. 2C.

It will be appreciated by those skilled in the art that the level of detail displayed by the project management application 128 for the project schedule data 204 may need to be altered when the scope 206 of the data included in the new time period changes substantially from the previous scope displayed. For example, as illustrated in FIGS. 2B-2C, the project management application 128 may change the level of detail reflected by the timescale for the displayed data from weekly detail to daily detail when the pan and zoom control 210 is resized in relation to the timeline 208 to a size substantially smaller than the previous display. From operation 422, the routine 400 returns to operation 408, where the project management application 128 waits for any additional movement or resizing of the pan and zoom control 210 by the user.

Based on the foregoing, it should be appreciated that technologies for providing a pan and zoom control in conjunction with the display of a timeline for navigating project schedule data in a project management application are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing a pan and zoom control in conjunction with a display of a timeline in a project management application, the method comprising:
detecting the display of the timeline by the project management application;
upon detecting the display of the timeline, determining a scope of displayed project schedule data; and
displaying the pan and zoom control in proximity to the timeline at a position and a size relative to the timeline corresponding to the scope.

2. The method of claim 1 wherein the pan and zoom control is configured to be moved along the timeline and resized by a user of the project management application utilizing an input device.

3. The method of claim 2, further comprising:
detecting a movement of the pan and zoom control along the timeline to a new position;
upon detecting the movement of the pan and zoom control, determining a time period represented by the new position and the size of the pan and zoom control in relation to the timeline; and
changing the scope of the displayed project schedule data to substantially match the time period.

4. The method of claim 2, further comprising:
detecting a resizing of the pan and zoom control relative to the timeline to a new size;
upon detecting the resizing of the pan and zoom control, determining a time period represented by the new size and the position of the pan and zoom control in relation to the timeline; and
changing the scope of the displayed project schedule data to substantially match the time period.

5. The method of claim 4, further comprising:
upon detecting resizing of the pan and zoom control, determining if the new size of the pan and zoom control substantially encompasses all of the timeline; and
upon determining that the new size of the pan and zoom control substantially encompasses all of the timeline, removing the pan and zoom.

6. The method of claim 1, wherein the timeline is displayed horizontally and the pan and zoom control is displayed as a horizontal bar parallel to and above the timeline, the size and position of the pan and zoom control relative to the timeline indicating a time period corresponding to the scope of the displayed project schedule data.

7. The method of claim 6, wherein a begin date of the time period is displayed at a first end of the pan and zoom control and an end date of the time period is displayed at a second end of the pan and zoom control.

8. The method of claim 6, wherein display attributes of the timeline are altered to emphasize a portion of the timeline corresponding to the time period.

9. The method of claim 1, further comprising:
detecting a change in the scope of the displayed project schedule data; and
upon detecting the change in the scope, changing the position and the size of the pan and zoom control relative to the timeline to reflect the scope.

10. The method of claim 1, wherein the project schedule data comprises one of a GANTT chart and tabular data.

11. A computer storage medium comprising computer-executable instructions that, when executed by a computer, will cause the computer to:
determine a scope of any project schedule data displayed by a project management application; and
display a pan and zoom control in proximity to a timeline at a position and a size relative to the timeline corresponding to the scope of the project schedule data, the pan and zoom control configured to be moved along the timeline and resized by a user of the project management application.

12. The computer storage medium of claim 11, further comprising computer-executable instructions that, when executed by the computer, will cause the computer to:
detect a movement of the pan and zoom control along the timeline to a new position;
upon detecting the movement of the pan and zoom control, determine a time period represented by the new position and the size of the pan and zoom control in relation to the timeline; and
change the scope of the project schedule data displayed to substantially match the time period.

13. The computer storage medium of claim 11, further comprising computer-executable instructions that, when executed by a computer, will cause the computer to:
detect a resizing of the pan and zoom control relative to the timeline to a new size;
upon detecting the resizing of the pan and zoom control, determining if the new size of the pan and zoom control substantially encompasses all of the timeline;
upon determining that the new size of the pan and zoom control substantially encompasses all of the timeline, removing the pan and zoom control;
upon determining that the new size of the pan and zoom control does not substantially encompass all of the timeline, determine a time period represented by the new size and the position of the pan and zoom control in relation to the timeline; and
change the scope of the project schedule data displayed to substantially match the time period.

14. The computer storage medium of claim 11, wherein the timeline is displayed horizontally and the pan and zoom control is displayed as a horizontal bar parallel to and above the timeline, the size and position of the pan and zoom control relative to the timeline indicating a time period corresponding to the scope of the project schedule data.

15. The computer storage medium of claim 14, wherein a begin date of the time period is displayed at a first end of the pan and zoom control and an end date of the time period is displayed at a second end of the pan and zoom control.

16. The computer storage medium of claim 11, further comprising computer-executable instructions that, when executed by a computer, will cause the computer to:
detect a change in the scope of the project schedule data; and
upon detecting the change in the scope, change the position and the size of the pan and zoom control relative to the timeline to reflect the scope.

17. A computer storage medium comprising computer-executable instructions that, when executed by a computer, will cause the computer to:
detect a display of a timeline by a project management application;
upon detecting the display of the timeline, determine a scope of any displayed project schedule data;
display a pan and zoom control in proximity to the timeline at a position and a size relative to the timeline corresponding to the scope, the pan and zoom control configured to be moved along the timeline and resized by a user of the project management application utilizing an input device;
detect a movement of the pan and zoom control along the timeline to a new position;
upon detecting the movement of the pan and zoom control, determine a time period represented by the new position and the size of the pan and zoom control in relation to the timeline;
change the scope of the displayed project schedule data to substantially match the time period;
detect a resizing of the pan and zoom control relative to the timeline to a new size;
upon detecting the resizing of the pan and zoom control, determine if the new size of the pan and zoom control substantially encompasses all of the timeline;
upon determining that the new size of the pan and zoom control substantially encompasses all of the timeline, remove the pan and zoom control;
upon determining that the new size of the pan and zoom control does not substantially encompass all of the timeline, determine a time period represented by the new size and the position of the pan and zoom control in relation to the timeline; and
change the scope of the displayed project schedule data to substantially match the time period.

18. The computer storage medium of claim 17, wherein the timeline is displayed horizontally and the pan and zoom control is displayed as a horizontal bar parallel to and above the timeline, the size and position of the pan and zoom control relative to the timeline indicating a time period corresponding to the scope of the displayed project schedule data.

19. The computer storage medium of claim 18, wherein a begin date of the time period is displayed at a first end of the pan and zoom control and an end date of the time period is displayed at a second end of the pan and zoom control.

20. The computer storage medium of claim 18, wherein display attributes of the timeline are altered to emphasize a portion of the timeline corresponding to the time period.
